(19) United States
(12) Patent Application Publication
(10) Pub. No.: US 2024/0371043 A1
(43) Pub. Date: Nov. 7, 2024

(54) PROCESSING IMAGE DATA IN AN EXTENDED-REALITY SYSTEM

(71) Applicant: QUALCOMM Incorporated, San Diego, CA (US)

(72) Inventors: Chirag Maheshkumar PUJARA, Bangalore (IN); Robert Peter VIEHAUSER, Bad Hofgastein (AT); Markus EDER, Salzburg (AT); Ajit Deepak GUPTE, Bangalore (IN)

(21) Appl. No.: 18/310,045

(22) Filed: May 1, 2023

(51) Int. Cl. G06T 9/00; G06T 5/00; G06T 5/20; G06T 7/20; G06V 10/25; G06V 10/28; G06V 10/74

(52) U.S. Cl. CPC G06T 9/00; G06T 5/20; G06T 5/70; G06T 7/20; G06V 10/25; G06V 10/28; G06V 10/761; G06V 2201/07

(57) ABSTRACT

Systems and techniques are described herein for processing image data. For instance, a method for processing image data is provided. The method may include capturing an image; determining at least one region of interest of the image based on at least one of object recognition, object tracking, hand tracking, semantic segmentation, saliency detection, or computer vision; encoding a first portion of the image according to a first parameter to generate first encoded data, the first portion of the image corresponding to the at least one region of interest; encoding a second portion of the image according to a second parameter to generate second encoded data; and transmitting, to a computing device, the first encoded data and the second encoded data.

### TECHNICAL FIELD

The present disclosure generally relates to processing image data in an extended-reality system. For example, aspects of the present disclosure include systems and techniques for capturing image data at a first device, encoding the image data for transmission to a second device, and transmitting the encoded data to the second device. Some aspects relate to receiving the transmitted encoded data and processing the encoded data at the second device.

### BACKGROUND

An extended reality (XR) (e.g., virtual reality (VR), augmented reality (AR), and/or mixed reality (MR)) system can provide a user with a virtual experience by displaying virtual content at a display mostly, or entirely, filling a user's field of view or by displaying virtual content overlaid onto, or alongside, a user's field of view of the real world (e.g., using a see-through or pass-through display).

XR systems typically include a display (e.g., a head-mounted display (HMD) or smart glasses), an image-capture device proximate to the display, and a processing device. In such XR systems, the image-capture device may capture images indicative of a field of view of user, the processing device may generate virtual content based on the field of view of the user, and the display may display the virtual content within the field of view of the user.

In some XR systems (e.g., split-architecture XR systems), the processing device may be separate from the display and/or image-capture device. For example, the processing device may be part of a companion device (e.g., a smartphone, a tablet, a laptop, a personal computer, or a server), while the display and image-capture device may be part of an XR device, such as an HMD, smart glasses, or other type of device.

In such split-architecture XR systems, the XR device may transmit image data (captured by the image-capture device) to the companion device and the companion device may determine or generate virtual-content data based on the image data. The companion device may then transmit the virtual-content data to the XR device for display using the display.

It may be desirable to limit the size of the image data transmitted by the XR device to the companion device. Limiting the size of the transmitted data may conserve bandwidth available for communications between the XR device and the companion device. Bandwidth can be measured in terms of bitrate, which refers to a number of bits that can be transmitted during a given time (e.g., bits per second). Conserving bandwidth may conserve power (e.g., by transmitting less data) and/or may allow for other data to be transmitted using the conserved bandwidth.

### BRIEF SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

Systems and techniques are described for processing image data. According to at least one example, a method is provided for processing image data. The method includes: capturing an image; determining at least one region of interest of the image based on at least one of object recognition, object tracking, hand tracking, semantic segmentation, saliency detection, or computer vision; encoding a first portion of the image according to a first parameter to generate first encoded data, the first portion of the image corresponding to the at least one region of interest; encoding a second portion of the image according to a second parameter to generate second encoded data; and transmitting, to a computing device, the first encoded data and the second encoded data.

In another example, an apparatus for processing image data is provided that includes at least one memory and at least one processor (e.g., configured in circuitry) coupled to the at least one memory. The at least one processor configured to: cause an image-capture device to capture an image; determine at least one region of interest of the image based on at least one of object recognition, object tracking, hand tracking, semantic segmentation, saliency detection, or computer vision; encode a first portion of the image according to a first parameter to generate first encoded data, the first portion of the image corresponding to the at least one region of interest; encode a second portion of the image according to a second parameter to generate second encoded data; and cause at least one transmitter to transmit, to a computing device, the first encoded data and the second encoded data. In some cases, the apparatus includes the image-capture device to capture the image. In some cases, the apparatus includes the at least one transmitter to transmit, to a computing device, the first encoded data and the second encoded data.

In another example, a non-transitory computer-readable medium is provided that has stored thereon instructions that, when executed by one or more processors, cause the one or more processors to: The at least one processor configured to: cause an image-capture device to capture an image; determine at least one region of interest of the image based on at least one of object recognition, object tracking, hand tracking, semantic segmentation, saliency detection, or computer vision; encode a first portion of the image according to a first parameter to generate first encoded data, the first portion of the image corresponding to the at least one region of interest; encode a second portion of the image according to a second parameter to generate second encoded data; and cause at least one transmitter to transmit, to a computing device, the first encoded data and the second encoded data.

In another example, an apparatus for processing image data is provided. The apparatus includes: means for capturing an image; means for determining at least one region of interest of the image based on at least one of object recognition, object tracking, hand tracking, semantic segmentation, saliency detection, or computer vision; means for encoding a first portion of the image according to a first parameter to generate first encoded data, the first portion of the image corresponding to the at least one region of interest; means for encoding a second portion of the image according to a second parameter to generate second encoded data; and means for transmitting, to a computing device, the first encoded data and the second encoded data.

Systems and techniques are described for processing image data. According to at least one example, a method is provided for processing image data. The method includes: receiving, at a computing device, from an image-capture device, first data encoding a first image; determining at least one region of interest of the first image; transmitting an indication of the at least one region of interest from the computing device to the image-capture device; receiving second data encoding a second image, a first portion of the second image encoded according to a first parameter, the first portion of the second image corresponding to the at least one region of interest, a second portion of the second image encoded according to a second parameter; decoding the second data to generate a reconstructed instance of the second image; and tracking an object in the reconstructed instance of the second image.

In another example, an apparatus for processing image data is provided that includes at least one memory and at least one processor (e.g., configured in circuitry) coupled to the at least one memory. The at least one processor configured to: receive, from an image-capture device, first data encoding a first image; determine at least one region of interest of the first image; transmit an indication of the at least one region of interest to the image-capture device; receive second data encoding a second image, a first portion of the second image encoded according to a first parameter, the first portion of the second image corresponding to the at least one region of interest, a second portion of the second image encoded according to a second parameter; decode the second data to generate a reconstructed instance of the second image; and track an object in the reconstructed instance of the second image. In some cases, the apparatus includes the at least one transmitter to transmit the indication of the at least one region of interest to the image-capture device.

In another example, a non-transitory computer-readable medium is provided that has stored thereon instructions that, when executed by one or more processors, cause the one or more processors to: receive, from an image-capture device, first data encoding a first image; determine at least one region of interest of the first image; transmit an indication of the at least one region of interest to the image-capture device; receive second data encoding a second image, a first portion of the second image encoded according to a first parameter, the first portion of the second image corresponding to the at least one region of interest, a second portion of the second image encoded according to a second parameter; decode the second data to generate a reconstructed instance of the second image; and track an object in the reconstructed instance of the second image.

In another example, an apparatus for processing image data is provided. The apparatus includes: means for receiving, at a computing device, from an image-capture device, first data encoding a first image; means for determining at least one region of interest of the first image; means for transmitting an indication of the at least one region of interest from the computing device to the image-capture device; means for receiving second data encoding a second image, a first portion of the second image encoded according to a first parameter, the first portion of the second image corresponding to the at least one region of interest, a second portion of the second image encoded according to a second parameter; means for decoding the second data to generate a reconstructed instance of the second image; and means for tracking an object in the reconstructed instance of the second image.

In some aspects, one or more of the apparatuses described herein is, can be part of, or can include a mobile device (e.g., a mobile telephone or so-called “smart phone”, a tablet computer, or other type of mobile device), an extended reality device (e.g., a virtual reality (VR) device, an augmented reality (AR) device, or a mixed reality (MR) device), a vehicle (or a computing device or system of a vehicle), a smart or connected device (e.g., an Internet-of-Things (IoT) device), a wearable device, a personal computer, a laptop computer, a video server, a television (e.g., a network-connected television), a robotics device or system, or other device. In some aspects, each apparatus can include an image sensor (e.g., a camera) or multiple image sensors (e.g., multiple cameras) for capturing one or more images. In some aspects, each apparatus can include one or more displays for displaying one or more images, notifications, and/or other displayable data. In some aspects, each apparatus can include one or more speakers, one or more light-emitting devices, and/or one or more microphones. In some aspects, each apparatus can include one or more sensors. In some cases, the one or more sensors can be used for determining a location of the apparatuses, a state of the apparatuses (e.g., a tracking state, an operating state, a temperature, a humidity level, and/or other state), and/or for other purposes.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative examples of the present application are described in detail below with reference to the following figures:

FIG. 1 is a diagram illustrating an example of an extended-reality (XR) system, according to aspects of the disclosure;

FIG. 2 is a diagram illustrating an architecture of an example XR system, in accordance with some aspects of the disclosure;

FIG. 3 is a block diagram illustrating another example XR system, according to various aspects of the present disclosure;

FIG. 4 is a diagram illustrating an example image that may be processed according to various aspects of the present disclosure;

FIG. 5 is a diagram illustrating another example image that may be processed according to various aspects of the present disclosure;

FIG. 6 is a diagram illustrating yet another example image that may be processed according to various aspects of the present disclosure;

FIG. 7 is a flow diagram illustrating an example process for processing image data, in accordance with aspects of the present disclosure;

FIG. 8 is a flow diagram illustrating another example process for processing image data, in accordance with aspects of the present disclosure;

FIG. 9 illustrates an example computing-device architecture of an example computing device which can implement the various techniques described herein.

### DETAILED DESCRIPTION

Certain aspects of this disclosure are provided below. Some of these aspects may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the exemplary aspects will provide those skilled in the art with an enabling description for implementing an exemplary aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage, or mode of operation.

Some extended-reality (XR) systems may employ computer-vision and/or perception processes which may include detection algorithms, recognition algorithms, and/or tracking algorithms. For example, a computer-vision process may receive images, detect (and/or recognize) real-world objects (e.g., people, hands, vehicles, etc.) in the images, and track the real-world objects in the images.

In some cases, when XR systems (including split-architecture XR systems) implement computer-vision and/or perception processes, most, or all, of the computer-vision and/or perception processes are implemented at a companion device of the XR system and not in an XR device of the XR system. For example, the XR device may capture images and provide the captured images to the companion device which may implement detection, recognition, and/or tracking algorithms.

As mentioned previously, in split-architecture XR systems it may be desirable to limit the size of the image data transmitted by an XR device to a companion device, for example, to limit power consumption of the XR device and/or to conserve bandwidth for other purposes.

Detection and/or recognition algorithms may operate on full images to detect real-world objects within the images. Tracking algorithms may focus on (or require only) portions of the images representative of the real-world objects. For example, a tracking algorithm may operate using pixels of a bounding box including a real-world object to be tracked and not require a full image in which the bounding box is found. In the present disclosure, the term “bounding box” may refer to a number of image pixels surrounding and including an object represented in the image pixels. An object-detection or object tracking algorithm may define a bounding box around an object.

One solution to limiting the size of transmissions from an XR device to a companion device of an XR system includes determining regions of interest within captured images (as an example, one or more bounding boxes may be determined to be respective regions of interest). The XR device can transmit image data of the regions of interest, without transmitting image data of the non-region-of-interest portions of the image. One issues with such a solution is that it may require transmitting separate image data for each of several separate regions of interest. In cases where the captured images are part of a series of images (e.g., frames of a video), such separate image-data transmissions would need to be synchronized to ensure that the relative timing of the region-of-interest data is synchronized across the series of images (e.g., as regions of interest across frames may arrive or be processed out of order, for example, based on transmission and/or processing latency). Such a solution may also require additional overhead in the transmissions (e.g., establishing separate data streams for each region of interest) and/or processing (e.g., requiring separate encoding/decoding sessions). Additionally, such a solution may allow multiple (e.g., double, triple, etc.) transmission of portions of the image (e.g., when portions of two or more regions of interest overlap). Additionally, such a solution may, in the event of an missing an identification of a region of interest, cause the missed region of interest to be unavailable for tracking.

Systems, apparatuses, methods (also referred to as processes), and computer-readable media (collectively referred to herein as “systems and techniques”) are described herein for processing image data in an XR system. The systems and techniques described herein may include an XR device, including an image-capture device, that may capture images. The XR device may determine one or more regions of interest within the images and may encode the images as encoded data for transmission. In encoding an image as encoded data, the XR device may encode non-region-of-interest portion(s) of the image (e.g., portions of the image that are not included in the region(s) of interest) using different parameters (e.g., using a higher quantization parameter (QP)) than the XR device uses to encode one or more regions of interest of the image. By encoding the non-region-of-interest portion(s) of the image using different parameters (e.g., using a greater QP), the systems and techniques may encode non-region-of-interest portion(s) using fewer bits than would be used if the non-region-of-interest portion(s) were encoded using the parameters used to encode the region(s) of interest. Encoding image data using fewer bits may conserve bandwidth when transmitting the encoded data.

For example, the portions of the encoded data representative of the non-region-of-interest portion(s) may be more dense per bit (e.g., represent more pixels with fewer encoded bits) than the portions of the encoded data representative of the region(s) of interest. The term “data density,” “density per bit,” and like terms, refers to a number of image pixels represented per bit of the encoded data used to represent the number of pixels. More dense encoding may cause a loss of image data when the image is reconstructed from the encoded data. Yet, by selecting non-region-of-interest portions of the image to encode more densely, object-detection, object-recognition, and/or object-tracking operations may not be impaired by such a loss of image data.

As an example of data density, first data representative of an image encoded using a first QP may have a first density. Second data representative of the same image encoded using a second QP (e.g., double the first QP) may have a second density that is greater than (e.g., double) the first density because the second data may be smaller (e.g., half as large) as the first data while still encoding the same image (albeit at a lower image quality). In another example, half of an image (e.g., a portion of the image including region(s) of interest) can be encoded using the first QP and the other half of the image (e.g., a non-region-of-interest portion(s) of the image) can be encoded using the second QP. The resulting data may be more dense than (e.g., 150% as dense as) the first data because the resulting data may be smaller (e.g., 75% as large) as the first data while still encoding the same image (albeit encoding half of the image at a lower image quality).

By increasing a data density, systems and techniques may use less bandwidth to transmit image data (e.g., between an XR device and a companion device in an XR system). Decreasing bandwidth used to transmit data may conserve power (e.g., power of the XR device) and/or allow the bandwidth to be used to transmit other data.

Various aspects of the application will be described with respect to the figures below.

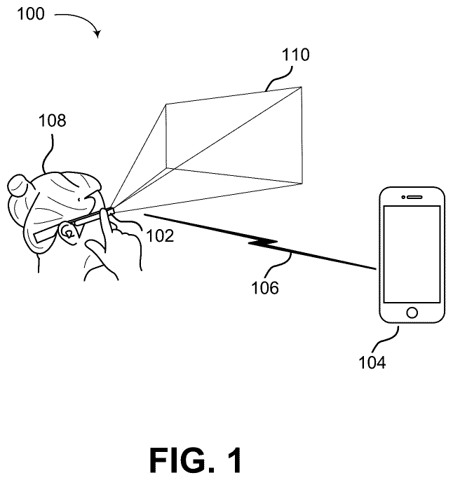

FIG. 1 is a diagram illustrating an example of an extended-reality (XR) system 100, according to aspects of the disclosure. As shown, XR system 100 includes an XR device 102, a companion device 104, and a communication link 106 between XR device 102 and companion device 104. In some cases, XR device 102 may generally implement display, image-capture, and/or view-tracking aspects of extended reality, including virtual reality (VR), augmented reality (AR), mixed reality (MR), etc. In some cases, companion device 104 may generally implement computing aspects of extended reality. For example, XR device 102 may capture images of an environment of a user 108 and provide the images to companion device 104 (e.g., via communication link 106). Companion device 104 may render virtual content (e.g., related to the captured images of the environment) and provide the virtual content to XR device 102 (e.g., via communication link 106). XR device 102 may display the virtual content to a user 108 (e.g., within a field of view 110 of user 108).

Generally, XR device 102 may display virtual content to be viewed by a user 108 in field of view 110. In some examples, XR device 102 may include a transparent surface (e.g., optical glass) such that virtual objects may be displayed on (e.g., by being generated at or projected onto) the transparent surface to overlay virtual content on real-word objects viewed through the transparent surface (e.g., in a see-through configuration). In some cases, XR device 102 may include a camera and may display both real-world objects (e.g., as frames or images captured by the camera) and virtual objects overlaid on the displayed real-world objects (e.g., in a pass-through configuration). In various examples, XR device 102 may include aspects of a virtual reality headset, smart glasses, a live feed video camera, a GPU, one or more sensors (e.g., such as one or more inertial measurement units (IMUs), image sensors, microphones, etc.), one or more output devices (e.g., such as speakers, display, smart glass, etc.), etc.

Companion device 104 may render the virtual content to be displayed by companion device 104. In some examples, companion device 104 may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Communication link 106 may be a wired or wireless connection according to any suitable wireless protocol, such as, for example, universal serial bus (USB), ultra wideband (UWB), Institute of Electrical and Electronics Engineers (IEEE) 802.11 (Wi-Fi), IEEE 802.15, or Bluetooth®. In some cases, communication link 106 may be a direct wireless connection between XR device 102 and companion device 104. In other cases, communication link 106 may be through one or more intermediary devices, such as, for example, routers or switches and/or across a network.

According to various aspects, XR device 102 may capture images and provide the captured images to companion device 104. Companion device 104 may implement detection, recognition, and/or tracking algorithms based on the captured images.

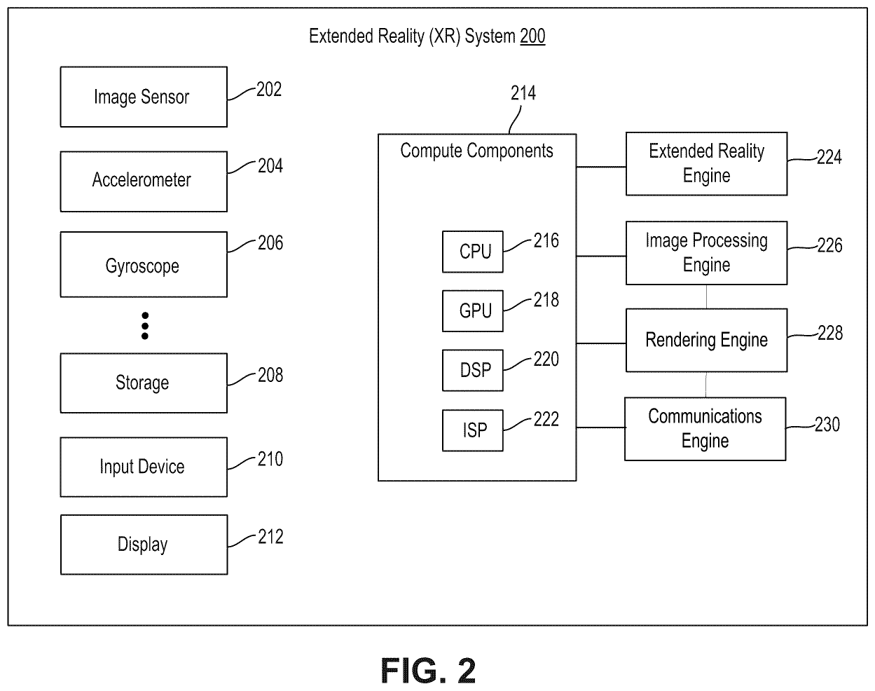

FIG. 2 is a diagram illustrating an architecture of an example extended reality (XR) system 200, in accordance with some aspects of the disclosure. XR system 200 may execute XR applications and implement XR operations.

In this illustrative example, XR system 200 includes one or more image sensors 202, an accelerometer 204, a gyroscope 206, storage 208, an input device 207, a display 212, compute components 214, an XR engine 224, an image processing engine 226, a rendering engine 228, and a communications engine 230. It should be noted that the components 202-230 shown in FIG. 2 are non-limiting examples provided for illustrative and explanation purposes, and other examples may include more, fewer, or different components than those shown in FIG. 2. For example, in some cases, XR system 200 may include one or more other sensors (e.g., one or more inertial measurement units (IMUs), radars, light detection and ranging (LIDAR) sensors, radio detection and ranging (RADAR) sensors, sound detection and ranging (SODAR) sensors, sound navigation and ranging (SONAR) sensors. audio sensors, etc.), one or more display devices, one more other processing engines, one or more other hardware components, and/or one or more other software and/or hardware components that are not shown in FIG. 2. While various components of XR system 200, such as image sensor 202, may be referenced in the singular form herein, it should be understood that XR system 200 may include multiple of any component discussed herein (e.g., multiple image sensors 202).

Display 212 may be, or may include, a glass, a screen, a lens, a projector, and/or other display mechanism that allows a user to see the real-world environment and also allows XR content to be overlaid, overlapped, blended with, or otherwise displayed thereon.

XR system 200 may include, or may be in communication with, (wired or wirelessly) an input device 210. Input device 210 may include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device discussed herein, or any combination thereof. In some cases, image sensor 202 may capture images that may be processed for interpreting gesture commands.

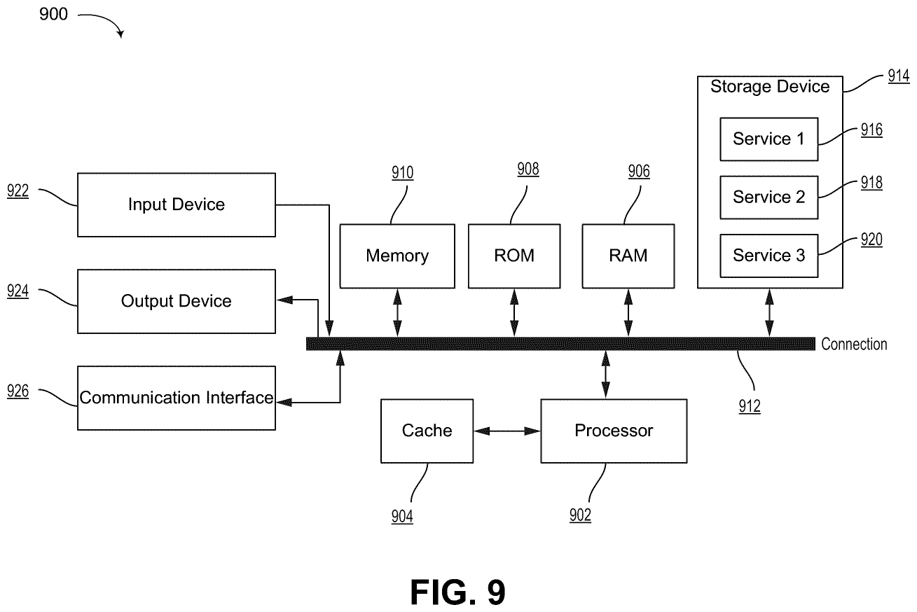

XR system 200 may also communicate with one or more other electronic devices (wired or wirelessly). For example, communications engine 230 may be configured to manage connections and communicate with one or more electronic devices. In some cases, communications engine 230 may correspond to communication interface 926 of FIG. 9.

In some implementations, image sensors 202, accelerometer 204, gyroscope 206, storage 208, display 212, compute components 214, XR engine 224, image processing engine 226, and rendering engine 228 may be part of the same device. For example, in some cases, image sensors 202, accelerometer 204, gyroscope 206, storage 208, display 212, compute components 214, XR engine 224, image processing engine 226, and rendering engine 228 may be integrated into an HMD, extended reality glasses, smartphone, laptop, tablet computer, gaming system, and/or any other computing device. However, in some implementations, image sensors 202, accelerometer 204, gyroscope 206, storage 208, display 212, compute components 214, XR engine 224, image processing engine 226, and rendering engine 228 may be part of two or more separate computing devices. For instance, in some cases, some of the components 202-230 may be part of, or implemented by, one computing device and the remaining components may be part of, or implemented by, one or more other computing devices. For example, such as in a split perception XR system, XR system 200 may include a first device (e.g., an XR device such as XR device 102 of FIG. 1), including display 212, image sensor 202, accelerometer 204, gyroscope 206, and/or one or more compute components 214. XR system 200 may also include a second device including additional compute components 214 (e.g., implementing XR engine 224, image processing engine 226, rendering engine 228, and/or communications engine 230). In such an example, the second device may generate virtual content based on information or data (e.g., images, sensor data such as measurements from accelerometer 204 and gyroscope 206) and may provide the virtual content to the first device for display at the first device. The second device may be, or may include, a smartphone, laptop, tablet computer, personal computer, gaming system, a server computer or server device (e.g., an edge or cloud-based server, a personal computer acting as a server device, or a mobile device acting as a server device), any other computing device and/or a combination thereof.

Storage 208 may be any storage device(s) for storing data. Moreover, storage 208 may store data from any of the components of XR system 200. For example, storage 208 may store data from image sensor 202 (e.g., image or video data), data from accelerometer 204 (e.g., measurements), data from gyroscope 206 (e.g., measurements), data from compute components 214 (e.g., processing parameters, preferences, virtual content, rendering content, scene maps, tracking and localization data, object detection data, privacy data, XR application data, face recognition data, occlusion data, etc.), data from XR engine 224, data from image processing engine 226, and/or data from rendering engine 228 (e.g., output frames). In some examples, storage 208 may include a buffer for storing frames for processing by compute components 214.

Compute components 214 may be, or may include, a central processing unit (CPU) 216, a graphics processing unit (GPU) 218, a digital signal processor (DSP) 220, an image signal processor (ISP) 222, and/or other processor (e.g., a neural processing unit (NPU) implementing one or more trained neural networks). Compute components 214 may perform various operations such as image enhancement, computer vision, graphics rendering, extended reality operations (e.g., tracking, localization, pose estimation, mapping, content anchoring, content rendering, predicting, etc.), image and/or video processing, sensor processing, recognition (e.g., text recognition, facial recognition, object recognition, feature recognition, tracking or pattern recognition, scene recognition, occlusion detection, etc.), trained machine-learning operations, filtering, and/or any of the various operations described herein. In some examples, compute components 214 may implement (e.g., control, operate, etc.) XR engine 224, image processing engine 226, and rendering engine 228. In other examples, compute components 214 may also implement one or more other processing engines.

Image sensor 202 may include any image and/or video sensors or capturing devices. In some examples, image sensor 202 may be part of a multiple-camera assembly, such as a dual-camera assembly. Image sensor 202 may capture image and/or video content (e.g., raw image and/or video data), which may then be processed by compute components 214, XR engine 224, image processing engine 226, and/or rendering engine 228 as described herein.

In some examples, image sensor 202 may capture image data and may generate images (also referred to as frames) based on the image data and/or may provide the image data or frames to XR engine 224, image processing engine 226, and/or rendering engine 228 for processing. An image or frame may include a video frame of a video sequence or a still image. An image or frame may include a pixel array representing a scene. For example, an image may be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, image sensor 202 (and/or other camera of XR system 200) may be configured to also capture depth information. For example, in some implementations, image sensor 202 (and/or other camera) may include an RGB-depth (RGB-D) camera. In some cases, XR system 200 may include one or more depth sensors (not shown) that are separate from image sensor 202 (and/or other camera) and that may capture depth information. For instance, such a depth sensor may obtain depth information independently from image sensor 202. In some examples, a depth sensor may be physically installed in the same general location or position as image sensor 202, but may operate at a different frequency or frame rate from image sensor 202. In some examples, a depth sensor may take the form of a light source that may project a structured or textured light pattern, which may include one or more narrow bands of light, onto one or more objects in a scene. Depth information may then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

XR system 200 may also include other sensors in its one or more sensors. The one or more sensors may include one or more accelerometers (e.g., accelerometer 204), one or more gyroscopes (e.g., gyroscope 206), and/or other sensors. The one or more sensors may provide velocity, orientation, and/or other position-related information to compute components 214. For example, accelerometer 204 may detect acceleration by XR system 200 and may generate acceleration measurements based on the detected acceleration. In some cases, accelerometer 204 may provide one or more translational vectors (e.g., up/down, left/right, forward/back) that may be used for determining a position or pose of XR system 200. Gyroscope 206 may detect and measure the orientation and angular velocity of XR system 200. For example, gyroscope 206 may be used to measure the pitch, roll, and yaw of XR system 200. In some cases, gyroscope 206 may provide one or more rotational vectors (e.g., pitch, yaw, roll). In some examples, image sensor 202 and/or XR engine 224 may use measurements obtained by accelerometer 204 (e.g., one or more translational vectors) and/or gyroscope 206 (e.g., one or more rotational vectors) to calculate the pose of XR system 200. As previously noted, in other examples, XR system 200 may also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors may include at least one IMU. An IMU is an electronic device that measures the specific force, angular rate, and/or the orientation of XR system 200, using a combination of one or more accelerometers, one or more gyroscopes, and/or one or more magnetometers. In some examples, the one or more sensors may output measured information associated with the capture of an image captured by image sensor 202 (and/or other camera of XR system 200) and/or depth information obtained using one or more depth sensors of XR system 200.

The output of one or more sensors (e.g., accelerometer 204, gyroscope 206, one or more IMUs, and/or other sensors) can be used by XR engine 224 to determine a pose of XR system 200 (also referred to as the head pose) and/or the pose of image sensor 202 (or other camera of XR system 200). In some cases, the pose of XR system 200 and the pose of image sensor 202 (or other camera) can be the same. The pose of image sensor 202 refers to the position and orientation of image sensor 202 relative to a frame of reference (e.g., with respect to a field of view 110 of FIG. 1). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees Of Freedom (3DoF), which refers to the three angular components (e.g., roll, pitch, and yaw).

In some cases, a device tracker (not shown) can use the measurements from the one or more sensors and image data from image sensor 202 to track a pose (e.g., a 6DoF pose) of XR system 200. For example, the device tracker can fuse visual data (e.g., using a visual tracking solution) from the image data with inertial data from the measurements to determine a position and motion of XR system 200 relative to the physical world (e.g., the scene) and a map of the physical world. As described below, in some examples, when tracking the pose of XR system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of XR system 200 within the scene and the 3D map of the scene, etc. The 3D map can provide a digital representation of a scene in the real/physical world. In some examples, the 3D map can anchor position-based objects and/or content to real-world coordinates and/or objects. XR system 200 can use a mapped scene (e.g., a scene in the physical world represented by, and/or associated with, a 3D map) to merge the physical and virtual worlds and/or merge virtual content or objects with the physical environment.

In some aspects, the pose of image sensor 202 and/or XR system 200 as a whole can be determined and/or tracked by compute components 214 using a visual tracking solution based on images captured by image sensor 202 (and/or other camera of XR system 200). For instance, in some examples, compute components 214 can perform tracking using computer vision-based tracking, model-based tracking, and/or simultaneous localization and mapping (SLAM) techniques. For instance, compute components 214 can perform SLAM or can be in communication (wired or wireless) with a SLAM system (not shown). SLAM refers to a class of techniques where a map of an environment (e.g., a map of an environment being modeled by XR system 200) is created while simultaneously tracking the pose of a camera (e.g., image sensor 202) and/or XR system 200 relative to that map. The map can be referred to as a SLAM map and can be three-dimensional (3D). The SLAM techniques can be performed using color or grayscale image data captured by image sensor 202 (and/or other camera of XR system 200) and can be used to generate estimates of 6DoF pose measurements of image sensor 202 and/or XR system 200. Such a SLAM technique configured to perform 6DoF tracking can be referred to as 6DoF SLAM. In some cases, the output of the one or more sensors (e.g., accelerometer 204, gyroscope 206, one or more IMUs, and/or other sensors) can be used to estimate, correct, and/or otherwise adjust the estimated pose.

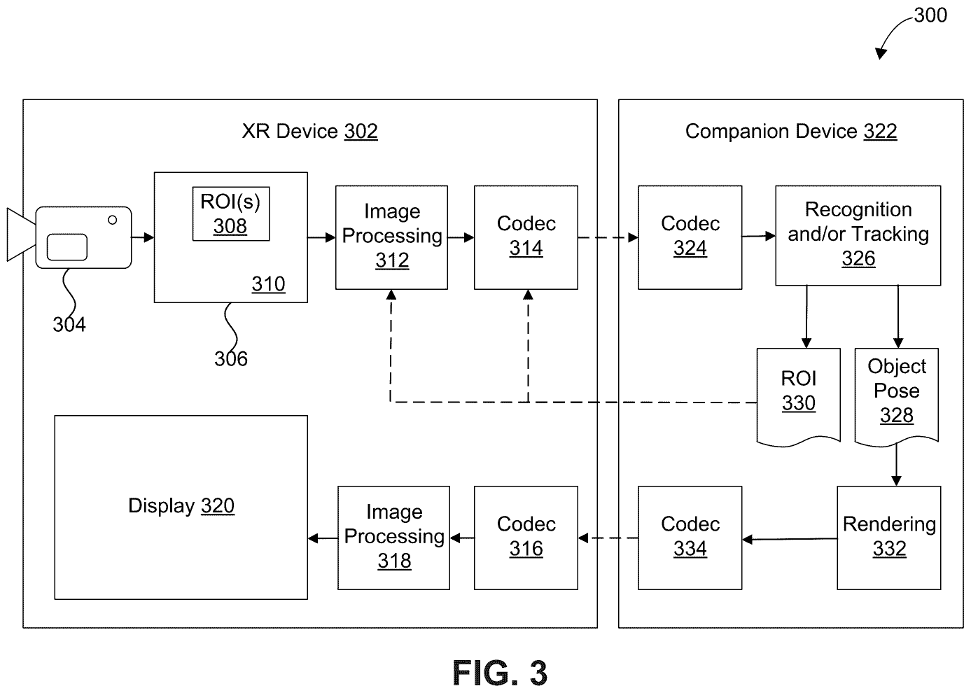

FIG. 3 is a block diagram illustrating an example extended-reality (XR) system 300, according to various aspects of the present disclosure. XR system 300 may include an XR device 302 and a companion device 322. XR device 302 may be a head-borne device (e.g., an HMD, smart glasses, or the like). XR device 302 may be an example of XR device 102 of FIG. 1. Companion device 322 may be, may be included in, or may be implemented in a computing device, such as a mobile phone, a tablet, a laptop, a personal computer, a server, a computing system of a vehicle, or other computing device. Companion device 322 may be an example of companion device 104 of FIG. 1.

The XR device 302 includes an image-capture device 304 that may capture one or more images 306 (e.g., the image-capture device may capture image(s) 306 continuously). Image(s) 306 may be, or may include, single-view images (e.g., monocular images) or multi-view images (e.g., stereoscopically paired images). Image(s) 306 may include one or more regions of interest (ROIs) 308 and one more non-region-of-interest portions 310. When image(s) 306 are captured, XR device 302 may, or may not, distinguish between region(s) of interest 308 and non-region-of-interest portion(s) 310. According to a first example, XR device 302 may identify region(s) of interests 308 (e.g., based on a gaze of the user based on images captured by another camera directed towards the eyes of the user (not illustrated in FIG. 3)). According to a second example, companion device 322 may identify region(s) of interests 308 within image(s) 306 according to one or more techniques (as will be described with more detail below) and provide ROI information 330 indicative of region(s) of interest 308 to XR device 302. XR device 302 may parse newly-captured image(s) 306 according to region(s) of interest 308 determined by companion device 322 based on previously-captured image(s) 306. For example, XR device 302 may identify pixels in the newly-captured image(s) 306 that correlate to the region(s) of interest 308 identified based on previously-captured image(s) 306.

XR device 302 may process image(s) 306 at an image-processing engine 312. Image-processing engine 312 may be a circuit or a chip (e.g., a field-programmable gate array (FPGA) or an image processor). Image-processing engine 312 may, among other things, filter image(s) 306 (e.g., to remove noise). In some cases, image-processing engine 312 may receive ROI information 330 and apply a low-pass filter to non-region-of-interest portion(s) 310 of image(s) 306. Applying the low-pass filter may remove high-frequency spatial content from the image data which may allow the image data to be encoded (e.g., by an encoder 314) using fewer bits per pixel. Applying a low-pass filter to an image may have the effect of blurring the image. Because the low-pass filter is applied to non-region-of-interest portion(s) 310, and not to region(s) of interest 308, companion device 322 may not be impaired in its ability to detect, recognize, and/or track objects in region(s) of interest 308 of image(s) 306.

Image-processing engine 312 may provide processed image data to encoder 314 (which may be a combined encoding-decoding device, also referred to as a codec). Encoder 314 may be, or may implemented in, a circuit or a chip (e.g., an FPGA or a processor). Encoder 314 may encode the processed image data for transmission (e.g., as individual data packets for sequential transmission). In one illustrative example, encoder 314 can encode the image data based on a video coding standard, such as High-Efficiency Video Coding (HEVC), Versatile Video Coding (VVC), or another video coding standard. In another illustrative example, encoder 314 can encode the image data using a machine-learning system that is trained to encode images (e.g., trained using supervised, semi-supervised, or self-supervised learning techniques).

Encoder 314 may receive ROI information 330 and may, while encoding the image data, use different parameters (e.g., different quantization parameters (QPs)) when encoding the region(s) of interest 308 and non-region-of-interest portion(s) 310 of image(s) 306. Encoder 314 may support a quantization-parameter map having a block granularity. For example, encoder 314 may use a first QP to encode the region(s) of interest 308 and a second QP (e.g., higher than the first QP) to encode non-region-of-interest portion(s) 310 of image(s) 306. By encoding non-region-of-interest portion(s) 310 of the image data using the second (e.g., higher) QP, encoder 314 may generate encoded data that is more dense (e.g., comprised of fewer bits) than the encoded data would be if the first QP were used to encode the entirety of each of image(s) 306. For instance, because the image data is encoded using higher QPs to encode non-region-of-interest portion(s) 310 of image(s) 306, the encoded data may represent image(s) 306 using fewer bits than if the entirety of each of image(s) 306 were encoded using the first QP. Identifying region(s) of interest 308, and not using higher QPs for the region(s) of interest 308 may ensure that region(s) of interest 308 retain their original image quality, thus leaving object detect, recognition, and/or tracking abilities of companion device 322 unimpaired.

Additionally, or alternatively, image-processing engine 312 or encoder 314 may apply a mask to non-region-of-interest portion(s) 310 of image(s) 306 prior to encoding the image data. Such a mask may render non-region-of-interest portion(s) 310 as a uniform value (e.g., an average intensity of image(s) 306). Masking non-region-of-interest portion(s) 310 of image(s) 306 using a uniform value may cause the resulting image data to be encoded using fewer bits per pixel, for example, because the uniform values may be coded with skip mode.

Filtering the image data, or masking the image data, may provide an additional benefit if the data is subsequently encoded using different QPs. For example, applying different QPs while encoding may introduce artifacts into images (e.g., at quantization-difference boundaries). Applying a low-pass filter or mask may limit or decrease such artifacts.

Additionally, or alternatively, pixels of region(s) of interest 308 may be padded, which may reduce artificial discontinuities and/or enhance compression gain and/or subjective quality of region(s) of interest 308 in reconstructed images. Additionally, or alternatively, non-region-of-interest portion(s) 310 may be intra coded, which may reduce dynamic random access memory traffic.

In some cases, if an object being tracked is very close to image-capture device 304, the object may occupy a large portion of image(s) 306. A tracker algorithm may be able to work with lower quality images of the object (e.g., images encoded using a relatively high QP and/or images that were filtered) because features of the object may be easily detected and/or tracked because the object occupies a large portion of image(s) 306. In such cases the large portion of image(s) 306 occupied by the object can be encoded using a higher QP and/or can be filtered to conserver bandwidth.

Additionally, or alternatively, a QP (and/or low-pass filter passband) may be determined based on an inverse relationship with a distance between an object represented by region(s) of interest 308 and image-capture device 304. The distance between the object and the image-capture device 304 may be determined by companion device 322 (e.g., based on a stereoscopic image and/or a distance sensor of companion device 322). As an example, the farther away an object is from image-capture device 304, the lower the QP selected for encoding a region(s) of interest 308 representing the object may be. As another example, the farther away an object is from image-capture device 304, the larger the passband of the low-pass filter selected for filtering a region(s) of interest 308 representing the object may be. In some cases, QPs and/or passbands may be determined by recognition and/or tracking engine 326 (e.g., such that objects in region(s) of interest 308 of reconstructed images can be detected, recognized, and/or tracked).

After encoding the image data, XR device 302 may transmit the encoded data to companion device 322 (e.g., using a communication engine which is not illustrated in FIG. 3). The encoded data may include relatively few bits (e.g., based on the low-pass filtering of the image data, encoding portions of the image data using a relatively high QP, or masking the image data). In other words, the encoded data may include fewer bits than if the entire image were encoded using a low QP, not filtered, and not masked. The encoded data, including relatively few bits, can be transmitted using less bandwidth than would be used to transmit data encoded without low-pass filtering, using a relatively high QP for portions of the image data, and/or masking. Conserving bandwidth at XR device 302 may conserve power at XR device 302.

Companion device 322 may receive the encoded data (e.g., using a communication engine which is not illustrated in FIG. 3) and provide the encoded data to decoder 324. The line between encoder 314 and decoder 324 is illustrated using a dashed line to indicate that the communication of the encoded image data between encoder 314 and decoder 324 may be wired or wireless, for example, according to any suitable communication protocol such as, USB, UWB, Wi-Fi, IEEE 902.15, or Bluetooth®. Similarly, other lines between XR device 302 and companion device 322 (including the line between ROI information 330 and image-processing engine 312, the line between ROI information 330 and encoder 314, and the line between encoder 334 and decoder 316) are illustrated using dashed lines to indicate that the communications represented by such lines may be wired or wireless.

Decoder 324 (which may be a codec) may decode the encoded image data. Decoder 324 may be, or may implemented in, a circuit or a chip (e.g., an FPGA or a processor). The decoded image data may not be the same as image(s) 306. For example, the decoded image data may be different from image(s) 306 based on image-processing engine 312 applying a low-pass filter to the image data and/or applying a mask before encoding the image data and/or based on decoder 324 applying different QPs to the image data while encoding the image data. Nevertheless, based on image-processing engine 312 filtering and/or masking non-region-of-interest portion(s) 310 and not region(s) of interest 308, and/or based on encoder 314 using a relatively low QP when encoding region(s) of interest 308, region(s) of interest 308 may be substantially the same in the decoded image data as in image(s) 306.

Recognition and/or tracking engine 326 (which may be, or may implemented in, a circuit or a chip (e.g., an FPGA or a processor)) may receive the decoded image data and perform operations related to: object detection, object recognition, object tracking, hand tracking, semantic segmentation, saliency detection, and/or other computer-vision tasks using the decoded image data. For example, recognition and/or tracking engine 326 may identify region(s) of interest 308 based on based on an object-recognition technique (e.g., identifying an object represented in image(s) 306 and tracking the position of the object through multiple image(s) 306). As another example, recognition and/or tracking engine 326 may identify region(s) of interest 308 based on a hand-tracking technique (e.g., identifying a hand as a region of interest 308 and/or identifying a region of interest 308 using a hand as an indicator, such as the hand pointing at the region of interest 308). As another example, recognition and/or tracking engine 326 may identify region(s) of interest 308 based on a semantic-segmentation technique or a saliency-detection technique (e.g., determining important regions of image(s) 306).

Recognition and/or tracking engine 326 may identify region(s) of interest 308 so that recognition and/or tracking engine 326 can track objects in region(s) of interests 308. Region(s) of interest 308 may be related to objects detected and/or tracked by recognition and/or tracking engine 326. For example, region(s) of interest 308 may be bounding boxes including the detected and/or tracked objects.

Recognition and/or tracking engine 326 may generate ROI information 330 indicative of the determined region(s) of interest 308 and provide ROI information 330 to image-processing engine 312 and/or encoder 314. Additionally, or alternatively, recognition and/or tracking engine 326 may determine object pose 328. Object pose 328 may be indicative of a position and/or orientation of objects detected and/or tracked by recognition and/or tracking engine 326.

Rendering 332 (which may be, or may implemented in, a circuit or a chip (e.g., an FPGA or a processor)) may receive object pose 328 from recognition and/or tracking engine 326 and may render images for display by XR device 302 based on object pose 328. For example, rendering 332 may determine where in a display 320 of XR device 302 to display virtual content based on object pose 328. As an example, rendering 332 may determine to display virtual content to overlay tracked real-world objects within a field of view of a user.

Rendering 332 may provide the rendered images to encoder 334. In some cases, encoder 334 and decoder 324 may be included in the same circuit or chip. In other cases, encoder 334 may be independent of decoder 324. In any case, encoder 334 may be, or may implemented in, a circuit or a chip (e.g., an FPGA or a processor). Encoder 334 may encode the image data from rendering 332 for transmission (e.g., as individual data packets for sequential transmission). In one illustrative example, encoder 334 can encode the image data based on a video coding standard, such as HEVC, VVC, or another video coding standard. In another illustrative example, encoder 334 can encode the image data using a machine-learning system that is trained to encode images (e.g., trained using supervised, semi-supervised, or self-supervised learning techniques).

After encoding the image data, companion device 322 may transmit the encoded data to XR device 302 (e.g., using a communication engine which is not illustrated in FIG. 3). XR device 302 may receive the encoded data (e.g., using a communication engine which is not illustrated in FIG. 3) and decode the encoded data at a decoder 316. In some cases, decoder 316 and encoder 314 may be included in the same circuit or chip. In other cases, decoder 316 may be independent of encoder 314. In any case, decoder 316 may be, or may implemented in, a circuit or a chip (e.g., an FPGA or a processor).

Image-processing engine 318 may receive the decoded image data from decoder 316 and process the decoded images data. For example, image-processing engine 318 may perform one or more of: color conversion, error concealment, and/or image warping for display-time head pose (which may also be referred to in the art as late stage reprojection). Display 320 may receive the processed image data from image-processing engine 318 and display the image data.

In some cases, XR device 302 may periodically transmit additional image data entirely encoded using the one QP (e.g., a relatively low QP), without low-pass filtering or masking. Such images may allow recognition and/or tracking engine 326 to detect objects and/or identify additional region(s) of interest 308 or update region(s) of interest 308. Additionally, or alternatively, in some cases, recognition and/or tracking engine 326 may request that XR device 302 capture and send one or more image(s) 306 encoded using a relatively low QP and/or without low-pass filtering. Recognition and/or tracking engine 326 may request such image(s) 306 based on determining a possibility that a new object may be represented in such image(s) 306.

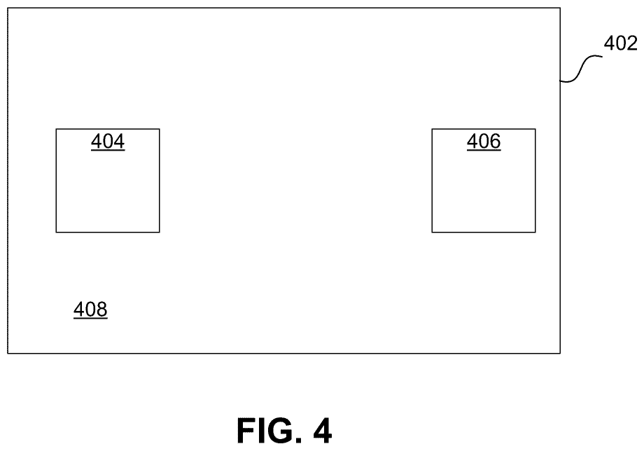

FIG. 4 is a diagram illustrating an example image 402 that may be processed according to various aspects of the present disclosure. For example, image 402 may be captured at an image-capture device (e.g., image-capture device 304 of FIG. 3) of an XR device (e.g., XR device 302 of FIG. 3 or XR device 102 of FIG. 1). Two regions of interest, region of interest 404 and region of interest 406, may be identified in image 402. According to some examples, region of interest 404 and region of interest 406 may be identified by a companion device (e.g., companion device 104 of FIG. 1 or companion device 322 of FIG. 3). As described above, region of interest 404 and region of interest 406 may be identified in image 402 based on a previous image of a series of images including image 402. As described above, region of interest 404 and region of interest 406 may be identified based on at least one of object recognition, object tracking, hand tracking, semantic segmentation, saliency detection, or computer vision. Pixels of image 402 that are not included in region of interest 404 or region of interest 406 may be a non-region-of-interest portion 408 of image 402.

In some examples, image 402 may be encoded using different parameters when encoding region of interest 404, region of interest 406, and non-region-of-interest portion 408. For example, a first quantization parameter (QP) may be used to encode region of interest 404 and/or region of interest 406 and a second QP (e.g., greater than the first QP) may be used to encode non-region-of-interest portion 408.

Additionally, or alternatively, prior to encoding, non-region-of-interest portion 408 may be filtered (e.g., using a low-pass filter). Additionally, or alternatively, non-region-of-interest portion 408 may be masked, for example, by modifying image 402 such that non-region-of-interest portion 408 is represented by a uniform value. The uniform value may be an average value (or on average intensity value) of image 402 or an average value (or an average intensity value) of non-region-of-interest portion 408.

By applying a relatively high QP (e.g., higher than the QP used to encode region of interest 404 and/or region of interest 406) when encoding non-region-of-interest portion 408, and/or by filtering or masking non-region-of-interest portion 408, encoded data representing image 402 may be smaller than the data would be without the relatively high QP, the filtering and/or the masking. The smaller data may require less bandwidth to transmit (e.g., from the XR device to the companion device).

In some aspects, if an image includes two (or more) regions of interest that are close to one another, or overlapping, systems and techniques may merge the two (or more) regions of interest and process the merged regions of interest as one.

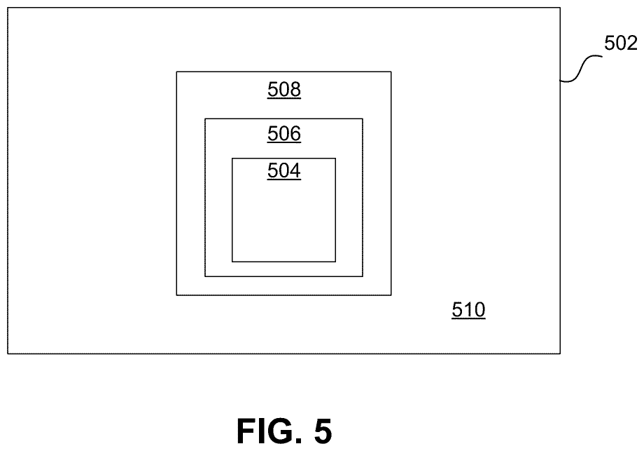

FIG. 5 is a diagram illustrating an example image 502 that may be processed according to various aspects of the present disclosure. For example, image 502 may be captured at an image-capture device (e.g., image-capture device 304 of FIG. 3) of an XR device (e.g., XR device 302 of FIG. 3 or XR device 102 of FIG. 1). A region of interest 504 may be identified in image 502. According to some examples, region of interest 504 may be identified by a companion device (e.g., companion device 104 of FIG. 1 or companion device 322 of FIG. 3). As described above, region of interest 504 may be identified in image 502 based on a previous image of a series of images including image 502. As described above, region of interest 504 may be identified based on at least one of object recognition, object tracking, hand tracking, semantic segmentation, saliency detection, or computer vision.

Pixels of image 502 that are not included in region of interest 504 may be a non-region-of-interest portion 510 of image 502. Non-region-of-interest portion 510 may include one or more regions surrounding region of interest 504, including, as examples, surrounding region 506 and surrounding region 508.

In some examples, image 502 may be encoded using different parameters when encoding region of interest 504, surrounding region 506, surrounding region 508, and non-region-of-interest portion 510. For example, a first QPs may be used to encode region of interest 504, a second QP (e.g., greater than the first QP) may be used to encode surrounding region 506, a third QP (e.g., greater than the second) may be used to encode surrounding region 508, and a fourth QP (e.g., greater than the third) may be used to encode non-region-of-interest portion 510.

Additionally, or alternatively, prior to encoding, surrounding region 506, surrounding region 508, and/or non-region-of-interest portion 510 may be filtered (e.g., using one or more low-pass filters). In some examples, different filters (e.g., with different pass bands) may be used to encode each of surrounding region 506, surrounding region 508, and non-region-of-interest portion 510. For example, a first low-pass filter with a first pass band may be applied to surrounding region 506, a second low-pass filter, with a second pass band (e.g., smaller than the first pass band) may be applied to surrounding region 508, and a third low-pass filter, with a third pass band (e.g., smaller than the second pass band) may be applied to non-region-of-interest portion 510.

Additionally, or alternatively, non-region-of-interest portion 510 (including surrounding region 506 and/or surrounding region 508) may be masked, for example, by modifying image 502 such that non-region-of-interest portion 510 is represented by a uniform value. The uniform value may be an average value (or on average intensity value) of image 502 or an average value (or an average intensity value) of non-region-of-interest portion 510.

By applying one or more different parameters when encoding non-region-of-interest portion 510, and/or by filtering or masking non-region-of-interest portion 510, encoded data representing image 502 may be smaller than the data would be without the different parameter, the filtering and/or the masking. The smaller data may require less bandwidth to transmit (e.g., from the XR device to the companion device).

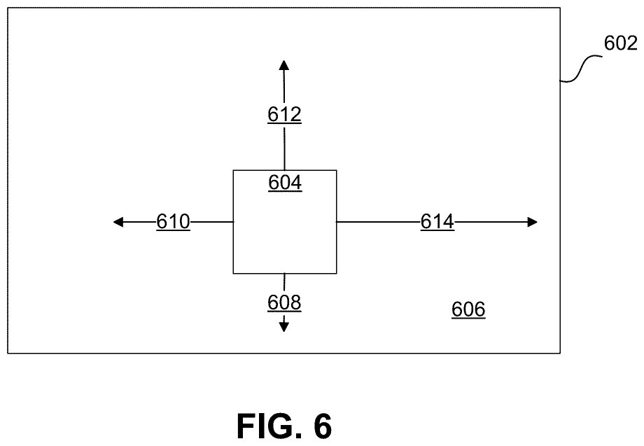

FIG. 6 is a diagram illustrating an example image 602 that may be processed according to various aspects of the present disclosure. For example, image 602 may be captured at an image-capture device (e.g., image-capture device 304 of FIG. 3) of an XR device (e.g., XR device 302 of FIG. 3 or XR device 102 of FIG. 1). A region of interest 604 may be identified in image 602. According to some examples, region of interest 604 may be identified by a companion device (e.g., companion device 104 of FIG. 1 or companion device 322 of FIG. 3). As described above, region of interest 604 may be identified in image 602 based on a previous image of a series of images including image 602. As described above, region of interest 604 may be identified based on at least one of object recognition, object tracking, hand tracking, semantic segmentation, saliency detection, or computer vision.

Pixels of image 602 that are not included in region of interest 604 may be a non-region-of-interest portion 606 of image 602. Non-region-of-interest portion 606 may include pixels that are a number of different respective distances from region of interest 604. For example, non-region-of-interest portion 606 may include pixels (e.g., a rectangular ring of pixels) that are substantially distance 608 from region of interest 604, pixels (e.g., a rectangular ring of pixels) that are substantially distance 610 from region of interest 604, pixels (e.g., a rectangular ring of pixels) that are substantially distance 612 from region of interest 604, and pixels (e.g., a rectangular ring of pixels) that are substantially distance 614 from region of interest 604.

In some examples, image 602 may be encoded using different parameters when encoding region of interest 604 and non-region-of-interest portion 606 based on a distance between region of interest 604 and the pixels being encoded.

For example, a first quantization parameter (QP) may be used to encode region of interest 604, a second QP (e.g., greater than the first QP) may be used to encode pixels that are substantially distance 608 from region of interest 604, a third QP (e.g., greater than the second) may be used to encode pixels that are substantially distance 610 from region of interest 604, a fourth QP (e.g., greater than the third) may be used to encode pixels that are substantially distance 612 from region of interest 604, and a fifth QP (e.g., greater than the fourth) may be used to encode pixels that are substantially distance 614 from region of interest 604. For example, a QP used to encode a given pixel may be determined based on a distance between the given pixel and region of interest 604.

Additionally, or alternatively, prior to encoding, non-region-of-interest portion 606 may be filtered (e.g., using one or more low-pass filters). In some examples, different filters (e.g., with different pass bands) may be used to encode different pixels of non-region-of-interest portion 606. For example, a first low-pass filter with a first pass band may be applied to pixels that are substantially distance 608 from region of interest 604, a second low-pass filter, with a second pass band (e.g., smaller than the first pass band) may be applied to pixels that are substantially distance 610 from region of interest 604, a third low-pass filter, with a third pass band (e.g., smaller than the second pass band) may be applied to pixels that are substantially distance 612 from region of interest 604, and a fourth low-pass filter, with a fourth pass band (e.g., smaller than the third pass band) may be applied to pixels that are substantially distance 614 from region of interest 604.

Additionally, or alternatively, non-region-of-interest portion 606 may be masked, for example, by modifying image 602 such that non-region-of-interest portion 606 is represented by a uniform value. The uniform value may be an average value (or on average intensity value) of image 602 or an average value (or an average intensity value) of non-region-of-interest portion 606.

By applying one or more different parameters when encoding non-region-of-interest portion 606, and/or by filtering or masking non-region-of-interest portion 606, encoded data representing image 602 may be smaller than the data would be without the different parameter, the filtering and/or the masking. The smaller data may require less bandwidth to transmit (e.g., from the XR device to the companion device).

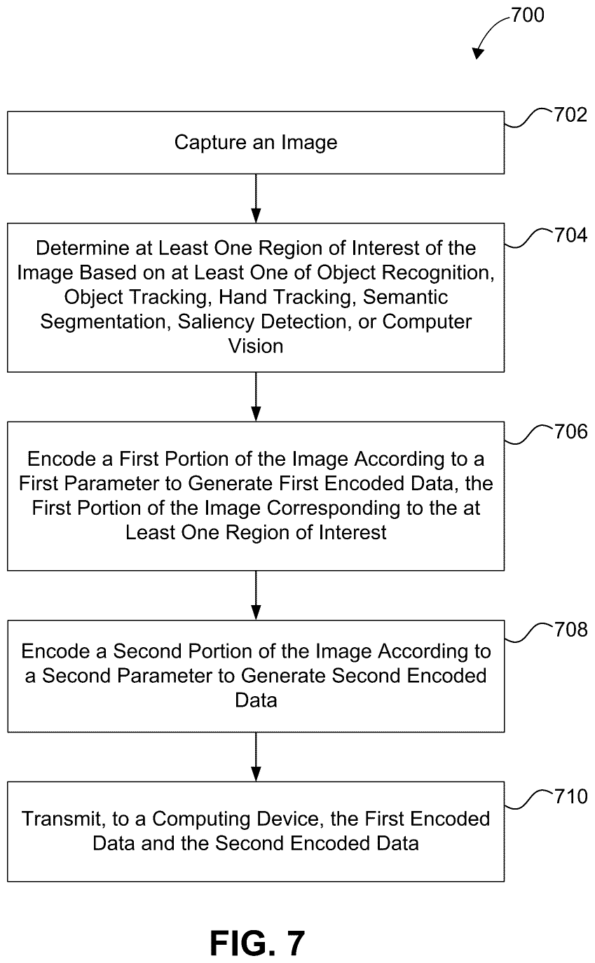

FIG. 7 is a flow diagram illustrating a process 700 for processing image data, in accordance with aspects of the present disclosure. One or more operations of process 700 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The one or more operations of process 700 may be implemented as software components that are executed and run on one or more processors.

At block 702, a computing device (or one or more components thereof) may capture an image. For example, XR device 302 of FIG. 3 may capture an image using image-capture device 304.

At block 704, the computing device (or one or more components thereof) may determine at least one region of interest of the image based on at least one of object recognition, object tracking, hand tracking, semantic segmentation, saliency detection, or computer vision. In some aspects, the computing device (or one or more components thereof) may receive, from another computing device, an indication of the at least one region of interest to determine the at least one region of interest. For example, XR device 302 may receive ROI information 330 of FIG. 3 from tracking engine 326 of FIG. 3. XR device 302 (e.g., the other computing device) and XR device 302 may determine the region of interest based on ROI information 330.

In some aspects, the region of interest may be determined to track at least one respective object represented in the at least one region of interest. For example, companion device 322 may determine the region of interest to track an object represented in the region of interest.

In some aspects, to determine the at least one region of interest the at least one processor may determine at least two regions of interest in the image. The first portion of the image may correspond to the at least two regions of interest. For example, the first portion may correspond to region of interest 404 and region of interest 406 of FIG. 4.

At block 706, the computing device (or one or more components thereof) may encode a first portion of the image according to a first parameter to generate first encoded data, the first portion of the image corresponding to the at least one region of interest. For example, XR device 302 may encode a first portion of the image captured at block 702 (the first portion corresponding to the region of interest determined at block 704) using a first parameter.

At block 708, the computing device (or one or more components thereof) may encode a second portion of the image according to a second parameter to generate second encoded data. For example, XR device 302 may encode a second portion of the image captured at block 702 (the second portion not corresponding to the region of interest determined at block 704) using a second parameter.

In some aspects, the first parameter may be, or may include, a first quantization parameter and the second parameter may be, or may include, a second quantization parameter, the second quantization parameter being greater than the first quantization parameter.

In some aspects, the computing device (or one or more components thereof) may encode a third portion of the image according to a third quantization parameter to generate third encoded data. The third portion of the image may surround the first portion of the image. The third quantization parameter may be greater than the first quantization parameter and less than the second quantization parameter. For example, region of interest 504 may be encoded using a first quantization parameter, non-region-of-interest portion 510 may be encoded using a second quantization parameter greater than the first quantization parameter and surrounding region 506 may be encoded using a third quantization parameter between the first and second quantization parameters.

In some aspects, the second quantization parameter may be, or may include, a plurality of quantization parameters. The second portion of the image may include a plurality of portions of the image. The computing device (or one or more components thereof) may encode each portion of the plurality of portions of the image using a respective quantization parameter of the plurality of quantization parameters to generate a plurality of encoded data. Each respective quantization parameter of the plurality of quantization parameters used to encode each portion of the plurality of portions of the image may be based on a distance between the first portion of the image and each respective portion of the plurality of portions of the image. For example, pixels substantially distance 608 from interest 604 may be encoded using a first quantization parameter, pixels substantially distance 610 from interest 604 may be encoded using a second quantization parameter, pixels substantially distance 612 from interest 604 may be encoded using a third quantization parameter, pixels substantially distance 614 from interest 604 may be encoded using a fourth quantization parameter.

In some aspects, the computing device (or one or more components thereof) may, while encoding the second portion of the image to generate the second encoded data, compress the second encoded data. In some aspects, the computing device (or one or more components thereof) may, prior to encoding the second portion of the image, blur the second portion of the image. In some aspects, the computing device (or one or more components thereof) may, prior to encoding the second portion of the image, filter the second portion of the image using a low-pass filter. In some aspects, the computing device (or one or more components thereof) may, prior to encoding the second portion of the image, mask the second portion of the image using a representative value of the image.

In some aspects, the computing device (or one or more components thereof) may determine the second parameter based on a bandwidth threshold such that transmitting the first encoded data and the second encoded data does not exceed the bandwidth threshold. In some aspects, the computing device (or one or more components thereof) may determine the second parameter based on an object-detection threshold.

At block 710, the computing device (or one or more components thereof) may transmit, to a computing device, the first encoded data and the second encoded data. For example, XR device 302 may transmit the data encoded at block 706 and block 708 to companion device 322.

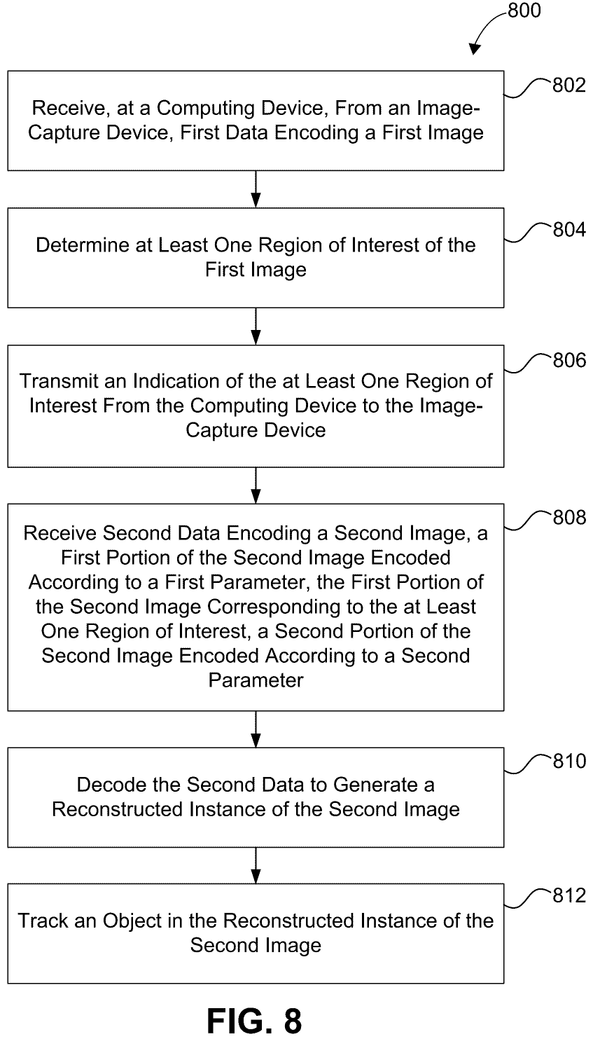

FIG. 8 is a flow diagram illustrating a process 800 for processing image data, in accordance with aspects of the present disclosure. One or more operations of process 800 may be performed by a computing device (or apparatus) or a component (e.g., a chipset, codec, etc.) of the computing device. The computing device may be a mobile device (e.g., a mobile phone), a network-connected wearable such as a watch, an extended reality (XR) device such as a virtual reality (VR) device or augmented reality (AR) device, a vehicle or component or system of a vehicle, or other type of computing device. The one or more operations of process 800 may be implemented as software components that are executed and run on one or more processors.

At block 802, a computing device (or one or more components thereof) may receive, from an image-capture device, first data encoding a first image. For example, companion device 322 of FIG. 3 may receive data encoding an image from XR device 302 of FIG. 3.

At block 804, the computing device (or one or more components thereof) may determine at least one region of interest of the first image. For example, companion device 322 may determine a region of interest of the image received at block 802.

In some aspects, the at least one region of interest may be determined based on at least one of object recognition, object tracking, hand tracking, semantic segmentation, saliency detection, or computer vision. In some aspects the computing device (or one or more components thereof) may determine the region of interest based on at least one of object recognition, object tracking, hand tracking, semantic segmentation, saliency detection, or computer vision.

In some aspects, the computing device (or one or more components thereof) may determine at least two regions of interest in the first image. The first portion of the second image may correspond to the at least two regions of interest. For example, region of interest 404 and region of interest 406 may be determined.

At block 806, the computing device (or one or more components thereof) may transmit an indication of the at least one region of interest to the image-capture device. For example, companion device 322 may transmit ROI information 330 which may be indicative of the region of interest determined at block 804.

At block 808, the computing device (or one or more components thereof) may receive second data encoding a second image, a first portion of the second image encoded according to a first parameter, the first portion of the second image corresponding to the at least one region of interest, a second portion of the second image encoded according to a second parameter. For example, companion device 322 may receive a second image from XR device 302. The second image may be encoded using different parameters for different regions. For example, a first parameter for the region of interest identified at block 804 than the parameter used to encode portions of the second image outside the region of interest.

At block 810, the computing device (or one or more components thereof) may decode the second data to generate a reconstructed instance of the second image. For example, companion device 322 may decode the data to reconstruct an instance of the second image.

At block 812, the computing device (or one or more components thereof) may track an object in the reconstructed instance of the second image. For example, companion device 322 may track an object represented in the reconstructed instance of the second image.

In some examples, the methods described herein (e.g., process 700, process 800 and/or other methods described herein) can be performed, in whole or in part, by a computing device or apparatus. In one example, one or more of the methods can be performed by XR system 100 of FIG. 1, XR device 102 of FIG. 1, companion device 104 of FIG. 1, XR system 200 of FIG. 2, XR system 300 of FIG. 3, XR device 302 of FIG. 3, companion device 322 of FIG. 3, or another system or device. In another example, one or more of the methods can be performed, in whole or in part, by the computing-device architecture 900 shown in FIG. 9. For instance, a computing device with the computing-device architecture 900 shown in FIG. 9 can include, or be included in, the components of the XR system 100 of FIG. 1, XR device 102 of FIG. 1, companion device 104 of FIG. 1, XR system 200 of FIG. 2, XR system 300 of FIG. 3, XR device 302 of FIG. 3, companion device 322 of FIG. 3, or another system or device and can implement the operations of the process 700, process 800, and/or other process described herein.

The computing device can include any suitable device, such as a vehicle or a computing device of a vehicle, a mobile device (e.g., a mobile phone), a desktop computing device, a tablet computing device, a wearable device (e.g., a VR headset, an AR headset, AR glasses, a network-connected watch or smartwatch, or other wearable device), a server computer, a robotic device, a television, and/or any other computing device with the resource capabilities to perform the processes described herein, including process 800, and/or other process described herein. In some cases, the computing device or apparatus can include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device can include a display, a network interface configured to communicate and/or receive the data, any combination thereof, and/or other component(s). The network interface can be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

Process 700, process 800, and/or other process described herein are illustrated as logical flow diagrams, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 700, process 800, and/or other process described herein can be performed under the control of one or more computer systems configured with executable instructions and can be implemented as code (e.g., executable instructions, one or more computer programs, or one or more applications) executing collectively on one or more processors, by hardware, or combinations thereof. As noted above, the code can be stored on a computer-readable or machine-readable storage medium, for example, in the form of a computer program comprising a plurality of instructions executable by one or more processors. The computer-readable or machine-readable storage medium can be non-transitory.

FIG. 9 illustrates an example computing-device architecture 900 of an example computing device which can implement the various techniques described herein. In some examples, the computing device can include a mobile device, a wearable device, an extended reality device (e.g., a virtual reality (VR) device, an augmented reality (AR) device, or a mixed reality (MR) device), a personal computer, a laptop computer, a video server, a vehicle (or computing device of a vehicle), or other device. For example, the computing-device architecture 900 may include, implement, or be included in, any or all of XR system 100 of FIG. 1, XR device 102 of FIG. 1, companion device 104 of FIG. 1, XR system 200 of FIG. 2, XR system 300 of FIG. 3, XR device 302 of FIG. 3, companion device 322 of FIG. 3, or another system or device.

The components of computing-device architecture 900 are shown in electrical communication with each other using connection 912, such as a bus. The example computing-device architecture 900 includes a processing unit (CPU or processor) 902 and computing device connection 912 that couples various computing device components including computing device memory 910, such as read only memory (ROM) 908 and random-access memory (RAM) 906, to processor 902.

Computing-device architecture 900 can include a cache of high-speed memory connected directly with, in close proximity to, or integrated as part of processor 902. Computing-device architecture 900 can copy data from memory 910 and/or the storage device 914 to cache 904 for quick access by processor 902. In this way, the cache can provide a performance boost that avoids processor 902 delays while waiting for data. These and other engines can control or be configured to control processor 902 to perform various actions. Other computing device memory 910 may be available for use as well. Memory 910 can include multiple different types of memory with different performance characteristics. Processor 902 can include any general-purpose processor and a hardware or software service, such as service 1 916, service 2 918, and service 3 920 stored in storage device 914, configured to control processor 902 as well as a special-purpose processor where software instructions are incorporated into the processor design. Processor 902 may be a self-contained system, containing multiple cores or processors, a bus, memory controller, cache, etc. A multi-core processor may be symmetric or asymmetric.

To enable user interaction with the computing-device architecture 900, input device 922 can represent any number of input mechanisms, such as a microphone for speech, a touch-sensitive screen for gesture or graphical input, keyboard, mouse, motion input, speech and so forth. Output device 924 can also be one or more of a number of output mechanisms known to those of skill in the art, such as a display, projector, television, speaker device, etc. In some instances, multimodal computing devices can enable a user to provide multiple types of input to communicate with computing-device architecture 900. Communication interface 926 can generally govern and manage the user input and computing device output. There is no restriction on operating on any particular hardware arrangement and therefore the basic features here may easily be substituted for improved hardware or firmware arrangements as they are developed.

Storage device 914 is a non-volatile memory and can be a hard disk or other types of computer readable media which can store data that are accessible by a computer, such as magnetic cassettes, flash memory cards, solid state memory devices, digital versatile disks, cartridges, random-access memories (RAMs) 906, read only memory (ROM) 908, and hybrids thereof. Storage device 914 can include services 916, 918, and 920 for controlling processor 902. Other hardware or software engines or modules are contemplated. Storage device 914 can be connected to the computing device connection 912. In one aspect, a hardware engine or module that performs a particular function can include the software component stored in a computer-readable medium in connection with the necessary hardware components, such as processor 902, connection 912, output device 924, and so forth, to carry out the function.

The term “substantially,” in reference to a given parameter, property, or condition, may refer to a degree that one of ordinary skill in the art would understand that the given parameter, property, or condition is met with a small degree of variance, such as, for example, within acceptable manufacturing tolerances. By way of example, depending on the particular parameter, property, or condition that is substantially met, the parameter, property, or condition may be at least 90% met, at least 95% met, or even at least 99% met.

Aspects of the present disclosure are applicable to any suitable electronic device (such as security systems, smartphones, tablets, laptop computers, vehicles, drones, or other devices) including or coupled to one or more active depth sensing systems. While described below with respect to a device having or coupled to one light projector, aspects of the present disclosure are applicable to devices having any number of light projectors and are therefore not limited to specific devices.

The term “device” is not limited to one or a specific number of physical objects (such as one smartphone, one controller, one processing system and so on). As used herein, a device may be any electronic device with one or more parts that may implement at least some portions of this disclosure. While the below description and examples use the term “device” to describe various aspects of this disclosure, the term “device” is not limited to a specific configuration, type, or number of objects. Additionally, the term “system” is not limited to multiple components or specific aspects. For example, a system may be implemented on one or more printed circuit boards or other substrates and may have movable or static components. While the below description and examples use the term “system” to describe various aspects of this disclosure, the term “system” is not limited to a specific configuration, type, or number of objects.

Specific details are provided in the description above to provide a thorough understanding of the aspects and examples provided herein. However, it will be understood by one of ordinary skill in the art that the aspects may be practiced without these specific details. For clarity of explanation, in some instances the present technology may be presented as including individual functional blocks including functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general-purpose computer, special purpose computer, or a processing device to perform a certain function or group of functions. Portions of computer resources used can be accessible over a network. The computer executable instructions may be, for example, binaries, intermediate format instructions such as assembly language, firmware, source code, etc.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, USB devices provided with non-volatile memory, networked storage devices, any suitable combination thereof, among others. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some aspects the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific aspects thereof, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of”' a set and/or “one or more” of a set does not limit the set to the items listed in the set. For example, claim language reciting “at least one of A and B” or “at least one of A or B” can mean A, B, or A and B, and can additionally include items not listed in the set of A and B.

The various illustrative logical blocks, modules, circuits, and algorithm steps described in connection with the aspects disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general-purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random-access memory (RAM) such as synchronous dynamic random-access memory (SDRAM), read-only memory (ROM), non-volatile random-access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general-purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

Illustrative aspects of the disclosure include:

Aspect 1. An apparatus for processing image data, the apparatus comprising: at least one memory; and at least one processor coupled to the at least one memory and configured to: cause an image-capture device to capture an image; determine at least one region of interest of the image based on at least one of object recognition, object tracking, hand tracking, semantic segmentation, saliency detection, or computer vision; encode a first portion of the image according to a first parameter to generate first encoded data, the first portion of the image corresponding to the at least one region of interest; encode a second portion of the image according to a second parameter to generate second encoded data; and cause at least one transmitter to transmit, to a computing device, the first encoded data and the second encoded data. In some cases, the apparatus includes the image-capture device to capture the image. In some cases, the apparatus includes the at least one transmitter to transmit, to a computing device, the first encoded data and the second encoded data.

Aspect 2. The apparatus of aspect 1, wherein the at least one region of interest is determined to track at least one respective object represented in the at least one region of interest.

Aspect 3. The apparatus of any one of aspects 1 or 2, wherein: to determine the at least one region of interest the at least one processor is configured to determine at least two regions of interest in the image; and the first portion of the image corresponds to the at least two regions of interest.

Aspect 4. The apparatus of any one of aspects 1 to 3, wherein to determine the at least one region of interest the at least one processor is configured to receive, from the computing device, an indication of the at least one region of interest.

Aspect 5. The apparatus of any one of aspects 1 to 4, wherein the first parameter comprises a first quantization parameter and the second parameter comprises a second quantization parameter, the second quantization parameter being greater than the first quantization parameter.

Aspect 6. The apparatus of aspect 5, wherein the at least one processor is further configured to: encode a third portion of the image according to a third quantization parameter to generate third encoded data, the third portion of the image surrounding the first portion of the image, the third quantization parameter being greater than the first quantization parameter and less than the second quantization parameter.

Aspect 7. The apparatus of aspect 6, wherein the second quantization parameter includes a plurality of quantization parameters and wherein the second portion of the image includes a plurality of portions of the image, wherein the at least one processor is further configured to: encode each portion of the plurality of portions of the image using a respective quantization parameter of the plurality of quantization parameters to generate a plurality of encoded data, wherein each respective quantization parameter of the plurality of quantization parameters used to encode each portion of the plurality of portions of the image is based on a distance between the first portion of the image and each respective portion of the plurality of portions of the image.

Aspect 8. The apparatus of any one of aspects 1 to 7, wherein the at least one processor is further configured to, while encoding the second portion of the image to generate the second encoded data, compress the second encoded data.

Aspect 9. The apparatus of any one of aspects 1 to 8, wherein the at least one processor is further configured to, prior to encoding the second portion of the image, blur the second portion of the image.

Aspect 10. The apparatus of any one of aspects 1 to 9, wherein the at least one processor is further configured to, prior to encoding the second portion of the image, filter the second portion of the image using a low-pass filter.

Aspect 11. The apparatus of any one of aspects 1 to 10, wherein the at least one processor is further configured to, prior to encoding the second portion of the image, mask the second portion of the image using a representative value of the image.

Aspect 12. The apparatus of any one of aspects 1 to 11, wherein the at least one processor is further configured to determine the second parameter based on a bandwidth threshold such that transmitting the first encoded data and the second encoded data does not exceed the bandwidth threshold.

Aspect 13. The apparatus of any one of aspects 1 to 12, wherein the at least one processor is further configured to determine the second parameter based on an object-detection threshold.

Aspect 14. An apparatus for processing image data, the apparatus comprising: at least one memory; and at least one processor coupled to the at least one memory and configured to: receive, from an image-capture device, first data encoding a first image; determine at least one region of interest of the first image; cause at least one transmitter to transmit an indication of the at least one region of interest to the image-capture device; receive second data encoding a second image, a first portion of the second image encoded according to a first parameter, the first portion of the second image corresponding to the at least one region of interest, a second portion of the second image encoded according to a second parameter; decode the second data to generate a reconstructed instance of the second image; and track an object in the reconstructed instance of the second image. In some cases, the apparatus includes the at least one transmitter to transmit, to a computing device, the first encoded data and the second encoded data.

Aspect 15. The apparatus of aspect 14, wherein the at least one region of interest was determined based on at least one of object recognition, object tracking, hand tracking, semantic segmentation, saliency detection, or computer vision. In some cases, the processor may be configured to determine the at least one region of interest based on at least one of object recognition, object tracking, hand tracking, semantic segmentation, saliency detection, or computer vision.

Aspect 16. The apparatus of any one of aspects 14 or 15, wherein: to determine the at least one region of interest the at least one processor is configured to determine at least two regions of interest in the first image; and the first portion of the second image corresponds to the at least two regions of interest.

Aspect 17. A method for processing image data, the method comprising: capturing an image; determining at least one region of interest of the image based on at least one of object recognition, object tracking, hand tracking, semantic segmentation, saliency detection, or computer vision; encoding a first portion of the image according to a first parameter to generate first encoded data, the first portion of the image corresponding to the at least one region of interest; encoding a second portion of the image according to a second parameter to generate second encoded data; and transmitting, to a computing device, the first encoded data and the second encoded data.

Aspect 18. The method of aspect 17, wherein the at least one region of interest is determined to track at least one respective object represented in the at least one region of interest.

Aspect 19. The method of any one of aspects 17 or 18, wherein: determining the at least one region of interest comprises determining at least two regions of interest in the image; and the first portion of the image corresponds to the at least two regions of interest.

Aspect 20. The method of any one of aspects 17 to 19, wherein determining the at least one region of interest comprises receiving, from the computing device, an indication of the at least one region of interest.

Aspect 21. The method of any one of aspects 17 to 19, wherein the first parameter comprises a first quantization parameter and the second parameter comprises a second quantization parameter, the second quantization parameter being greater than the first quantization parameter.

Aspect 22. The method of aspect 21, further comprising: encoding a third portion of the image according to a third quantization parameter to generate third encoded data, the third portion of the image surrounding the first portion of the image, the third quantization parameter being greater than the first quantization parameter and less than the second quantization parameter.

Aspect 23. The method of aspect 22, wherein the second quantization parameter includes a plurality of quantization parameters and wherein the second portion of the image includes a plurality of portions of the image, the method further comprising: encoding each portion of the plurality of portions of the image using a respective quantization parameter of the plurality of quantization parameters to generate a plurality of encoded data, wherein each respective quantization parameter of the plurality of quantization parameters used to encode each portion of the plurality of portions of the image is based on a distance between the first portion of the image and each respective portion of the plurality of portions of the image.

Aspect 24. The method of any one of aspects 17 to 23, further comprising, while encoding the second portion of the image to generate the second encoded data, compressing the second encoded data.

Aspect 25. The method of any one of aspects 17 to 24, further comprising, prior to encoding the second portion of the image, blurring the second portion of the image.

Aspect 26. The method of any one of aspects 17 to 25, further comprising, prior to encoding the second portion of the image, filtering the second portion of the image using a low-pass filter.

Aspect 27. The method of any one of aspects 17 to 26, further comprising, prior to encoding the second portion of the image, masking the second portion of the image using a representative value of the image.

Aspect 28. The method of any one of aspects 17 to 27, further comprising determining the second parameter based on a bandwidth threshold such that transmitting the first encoded data and the second encoded data does not exceed the bandwidth threshold.

Aspect 29. The method of any one of aspects 17 to 29, further comprising determining the second parameter based on an object-detection threshold.

Aspect 30. A method for processing image data, the method comprising: receiving, at a computing device, from an image-capture device, first data encoding a first image; determining at least one region of interest of the first image; transmitting an indication of the at least one region of interest from the computing device to the image-capture device; receiving second data encoding a second image, a first portion of the second image encoded according to a first parameter, the first portion of the second image corresponding to the at least one region of interest, a second portion of the second image encoded according to a second parameter; decoding the second data to generate a reconstructed instance of the second image; and tracking an object in the reconstructed instance of the second image.

Aspect 31. A method for processing image data by an extended-reality system, the method comprising: capturing a first image at an image-capture device of the extended-reality system; encoding the first image as first data; transmitting the first data from the image-capture device to a computing device of the extended-reality system; determining, at the computing device, at least one region of interest of the first image based on at least one of object recognition, object tracking, hand tracking, semantic segmentation, saliency detection, or computer vision; transmitting an indication of the at least one region of interest from the computing device to the image-capture device; capturing a second image at the image-capture device; encoding a first portion of the second image according to a first parameter to generate first encoded data, the first portion of the second image corresponding to the at least one region of interest; encoding a second portion of the second image according to a second parameter to generate second encoded data; and transmitting, from the image-capture device, to the computing device, the first encoded data and the second encoded data; decoding the first encoded data and the second encoded data to generate a reconstructed instance of the second image; and tracking an object in the reconstructed instance of the second image.

Aspect 32. A non-transitory computer-readable storage medium having stored thereon instructions that, when executed by at least one processor, cause the at least one processor to perform operations according to any of aspects 17 to 31.

Aspect 33. An apparatus for providing virtual content for display, the apparatus comprising one or more means for perform operations according to any of aspects 17 to 31.

What is claimed is:

1. An apparatus for processing image data, the apparatus comprising:
at least one memory; and
at least one processor coupled to the at least one memory and configured to:
cause an image-capture device to capture an image;
determine at least one region of interest of the image based on at least one of object recognition, object tracking, hand tracking, semantic segmentation, saliency detection, or computer vision;
encode a first portion of the image according to a first parameter to generate first encoded data, the first portion of the image corresponding to the at least one region of interest;
encode a second portion of the image according to a second parameter to generate second encoded data; and
cause at least one transmitter to transmit, to a computing device, the first encoded data and the second encoded data.

2. The apparatus of claim 1, wherein the at least one region of interest is determined to track at least one respective object represented in the at least one region of interest.

3. The apparatus of claim 1, wherein:
to determine the at least one region of interest the at least one processor is configured to determine at least two regions of interest in the image; and
the first portion of the image corresponds to the at least two regions of interest.

4. The apparatus of claim 1, wherein to determine the at least one region of interest the at least one processor is configured to receive, from the computing device, an indication of the at least one region of interest.

5. The apparatus of claim 1, wherein the first parameter comprises a first quantization parameter and the second parameter comprises a second quantization parameter, the second quantization parameter being greater than the first quantization parameter.

6. The apparatus of claim 5, wherein the at least one processor is further configured to: encode a third portion of the image according to a third quantization parameter to generate third encoded data, the third portion of the image surrounding the first portion of the image, the third quantization parameter being greater than the first quantization parameter and less than the second quantization parameter.

7. The apparatus of claim 6, wherein the second quantization parameter includes a plurality of quantization parameters and wherein the second portion of the image includes a plurality of portions of the image, wherein the at least one processor is further configured to:
encode each portion of the plurality of portions of the image using a respective quantization parameter of the plurality of quantization parameters to generate a plurality of encoded data, wherein each respective quantization parameter of the plurality of quantization parameters used to encode each portion of the plurality of portions of the image is based on a distance between the first portion of the image and each respective portion of the plurality of portions of the image.

8. The apparatus of claim 1, wherein the at least one processor is further configured to, while encoding the second portion of the image to generate the second encoded data, compress the second encoded data.

9. The apparatus of claim 1, wherein the at least one processor is further configured to, prior to encoding the second portion of the image, blur the second portion of the image.

10. The apparatus of claim 1, wherein the at least one processor is further configured to, prior to encoding the second portion of the image, filter the second portion of the image using a low-pass filter.

11. The apparatus of claim 1, wherein the at least one processor is further configured to, prior to encoding the second portion of the image, mask the second portion of the image using a representative value of the image.

12. The apparatus of claim 1, wherein the at least one processor is further configured to determine the second parameter based on a bandwidth threshold such that transmitting the first encoded data and the second encoded data does not exceed the bandwidth threshold.

13. The apparatus of claim 1, wherein the at least one processor is further configured to determine the second parameter based on an object-detection threshold.

14. An apparatus for processing image data, the apparatus comprising:
at least one memory; and
at least one processor coupled to the at least one memory and configured to:
receive, from an image-capture device, first data encoding a first image;
determine at least one region of interest of the first image;
cause at least one transmitter to transmit an indication of the at least one region of interest to the image-capture device;
receive second data encoding a second image, a first portion of the second image encoded according to a first parameter, the first portion of the second image corresponding to the at least one region of interest, a second portion of the second image encoded according to a second parameter;
decode the second data to generate a reconstructed instance of the second image; and
track an object in the reconstructed instance of the second image.

15. The apparatus of claim 14, wherein the at least one region of interest was determined based on at least one of object recognition, object tracking, hand tracking, semantic segmentation, saliency detection, or computer vision.

16. The apparatus of claim 14, wherein:
to determine the at least one region of interest the at least one processor is configured to determine at least two regions of interest in the first image; and
the first portion of the second image corresponds to the at least two regions of interest.

17. A method for processing image data, the method comprising:
capturing an image;
determining at least one region of interest of the image based on at least one of object recognition, object tracking, hand tracking, semantic segmentation, saliency detection, or computer vision;
encoding a first portion of the image according to a first parameter to generate first encoded data, the first portion of the image corresponding to the at least one region of interest;
encoding a second portion of the image according to a second parameter to generate second encoded data; and
transmitting, to a computing device, the first encoded data and the second encoded data.

18. The method of claim 17, wherein the at least one region of interest is determined to track at least one respective object represented in the at least one region of interest.

19. The method of claim 17, wherein:
determining the at least one region of interest comprises determining at least two regions of interest in the image; and
the first portion of the image corresponds to the at least two regions of interest.

20. The method of claim 17, wherein determining the at least one region of interest comprises receiving, from the computing device, an indication of the at least one region of interest.

21. The method of claim 17, wherein the first parameter comprises a first quantization parameter and the second parameter comprises a second quantization parameter, the second quantization parameter being greater than the first quantization parameter.

22. The method of claim 21, further comprising: encoding a third portion of the image according to a third quantization parameter to generate third encoded data, the third portion of the image surrounding the first portion of the image, the third quantization parameter being greater than the first quantization parameter and less than the second quantization parameter.

23. The method of claim 22, wherein the second quantization parameter includes a plurality of quantization parameters and wherein the second portion of the image includes a plurality of portions of the image, the method further comprising:
encoding each portion of the plurality of portions of the image using a respective quantization parameter of the plurality of quantization parameters to generate a plurality of encoded data, wherein each respective quantization parameter of the plurality of quantization parameters used to encode each portion of the plurality of portions of the image is based on a distance between the first portion of the image and each respective portion of the plurality of portions of the image.

24. The method of claim 17, further comprising, while encoding the second portion of the image to generate the second encoded data, compressing the second encoded data.

25. The method of claim 17, further comprising, prior to encoding the second portion of the image, blurring the second portion of the image.

26. The method of claim 17, further comprising, prior to encoding the second portion of the image, filtering the second portion of the image using a low-pass filter.

27. The method of claim 17, further comprising, prior to encoding the second portion of the image, masking the second portion of the image using a representative value of the image.

28. The method of claim 17, further comprising determining the second parameter based on a bandwidth threshold such that transmitting the first encoded data and the second encoded data does not exceed the bandwidth threshold.

29. The method of claim 17, further comprising determining the second parameter based on an object-detection threshold.

30. A method for processing image data, the method comprising:
receiving, at a computing device, from an image-capture device, first data encoding a first image;
determining at least one region of interest of the first image;
transmitting an indication of the at least one region of interest from the computing device to the image-capture device;
receiving second data encoding a second image, a first portion of the second image encoded according to a first parameter, the first portion of the second image corresponding to the at least one region of interest, a second portion of the second image encoded according to a second parameter;
decoding the second data to generate a reconstructed instance of the second image; and tracking an object in the reconstructed instance of the second image.
